(19) United States
(12) Patent Application Publication
(10) Pub. No.: US 2017/0214037 A1
(43) Pub. Date: Jul. 27, 2017

(54) NEGATIVE ELECTRODE FOR NONAQUEOUS ELECTROLYTE ENERGY STORAGE DEVICE, NONAQUEOUS ELECTROLYTE ENERGY STORAGE DEVICE, AND ENERGY STORAGE APPARATUS

(71) Applicant: GS Yuasa International Ltd., Kyoto-shi, Kyoto (JP)

(72) Inventors: Shinya UEMATSU, Kyoto (JP); Tomoya TSUCHIKAWA, Kyoto (JP); Hidefumi HASEGAWA, Kyoto (JP)

(73) Assignee: GS Yuasa International Ltd., Kyoto-shi, Kyoto (JP)

(21) Appl. No.: 15/514,927

(22) PCT Filed: Sep. 30, 2015
(86) PCT No.: PCT/JP2015/077809

§ 371 Date: Mar. 28, 2017

(30) Foreign Application Priority Data
Sep. 30, 2014 (JP) 2014-202070

(51) Int. Cl. H01M 4/133; G01N 23/20; H01M 10/052

(52) U.S. Cl. CPC H01M 4/133; H01M 10/052; G01N 23/20; H01M 2004/021

(57) ABSTRACT

In order to improve the insulating property of a covering layer containing a filler disposed on at least a part of a surface of a negative composite layer, there is provided a negative electrode for a nonaqueous electrolyte energy storage device, including a negative electrode including a current collector, a negative composite layer containing a negative active material, and a covering layer containing a filler on at least a part of a surface of the negative composite layer, wherein in X-ray diffraction (XRD) measurement of the negative electrode, a peak intensity ratio (I₍₀₀₂₎/I₍₁₀₀₎) between a diffraction peak attributed to (002) plane of the negative active material and a diffraction peak attributed to (100) plane of the negative active material is 219 or more and 862 or less.

### CROSS-REFERENCE TO RELATED APPLICATION

This application claims priority to Japanese Patent Application No. 2014-202070 which is herein incorporated by reference.

### TECHNICAL FIELD

The present invention relates to a negative electrode for a nonaqueous electrolyte energy storage device, and a nonaqueous electrolyte energy storage device and an energy storage apparatus each including the same.

### BACKGROUND ART

In recent years, nonaqueous electrolyte energy storage devices typified by a lithium ion secondary battery have been used in wide range of applications including a power supply for electric vehicles, a power supply for electronic equipment, and a power supply for electric power storage.

Higher safety is required in forms and situations of usage which cannot be foreseen in ordinary usage, in addition to requirements of an increase of energy density/increases of input power and output power, as the nonaqueous electrolyte energy storage device is widespread.

As one of efforts toward safety, investigations have been made about forming an insulating covering layer on a negative electrode.

Patent Document 1 discloses a technique of “ensuring uniform distribution of the nonaqueous electrolyte solution in the vicinity of the surface of a plate throughout a charge-discharge cycle, and thus providing a nonaqueous electrolyte solution secondary battery having a high capacity and excellent cycle life performance” (paragraph 0012) by employing “a nonaqueous electrolyte solution secondary battery including a negative electrode plate, a positive electrode plate, a separator or a lithium ion-conducting layer, and a nonaqueous electrolyte solution, wherein a porous insulating layer having a small compression deformation rate is disposed on at least one of an interface between the separator or the lithium ion-conducting layer and the negative electrode plate and an interface between the separator or the lithium ion-conducting layer and the positive electrode plate.” (claim 1).

Further, an example in which a porous insulating layer containing an inorganic filler is disposed on both surfaces of a negative electrode plate containing, as an active material, only flaky graphite pulverized and classified so as to have an average particle size of about 20 μm is described as batteries B1 to B9 of Example 1.

Patent Document 2 discloses a technique of “not only exerting excellent discharge characteristics at a high current density without impairing safety, but also exerting extremely higher performance than conventional batteries due to increase in an amount of an active material which can be accommodated per unit volume of a battery as compared to conventional batteries” by employing “a nonaqueous secondary battery including a casing, a nonaqueous electrolyte contained in the casing, a positive electrode including a positive active material layer, a negative electrode including a negative active material layer, and a porous separator, the positive electrode, the negative electrode, and the separator being accommodated cooperatively with the electrolyte in the casing, the porous separator being arranged between the positive electrode and the negative electrode in such a way that both surfaces of the porous separator face the positive active material layer and the negative active material layer, respectively, wherein the porous separator is made of at least one layer of insulating substance particle aggregate, the particle aggregate includes a binder which binds the particles together, the porous separator is directly formed in the form of being integrated on the surface of at least one active material layer selected from the group consisting of the positive active material layer and the negative active material layer, and the at least one layer of insulating substance particle aggregate has a three-dimensional mesh-cavity structure, which provides, in the porous separator, pores that allow passage of ions therethrough.” (claim 1).

In addition, Patent Document 2 describes an example (Example 2) in which an α-Al₂O₃ particle aggregate is fixed onto the negative active material layer containing, as a negative active material, mesophase pitch carbon fiber graphite and flaky graphite in a weight ratio of 90:10 to form a separator.

### PRIOR ART DOCUMENTS

### Patent Documents

Patent Document 1: JP-A-2007-87690
Patent Document 2: JP 3253632 B1

### DISCLOSURE OF THE INVENTION

### Problems to be Solved by the Invention

The present inventors have found that when a covering layer containing a filler is formed on a surface of a negative composite layer, a part of the filler infiltrates into the negative composite layer. Then, they have found that by this phenomenon, a region where the covering layer is partially thin or a region where filler distribution in the covering layer is markedly non-uniform emerges to deteriorate the insulating property of the covering layer.

Patent Documents 1 and 2 describe inventions of disposing a covering layer on a surface of a negative composite layer.

Patent Documents 1 and 2, however, do not disclose any measure for overcoming deterioration of the insulating property due to infiltration of the filler into the negative composite layer.

In view of the above-mentioned state of the art, it is an object of the present invention to improve the insulating property of a covering layer containing a filler, which is disposed on at least a part of a surface of a negative composite layer.

### Means for Solving the Problems

The present invention pertains to a negative electrode for a nonaqueous electrolyte energy storage device, including a negative electrode including a current collector, a negative composite layer containing a negative active material, and a covering layer containing a filler on at least a part of a surface of the negative composite layer, wherein in X-ray diffraction (XRD) measurement of the negative electrode, a peak intensity ratio (I₍₀₀₂₎/I₍₁₀₀₎) between a diffraction peak attributed to (002) plane of the negative active material and a diffraction peak attributed to (100) plane of the negative active material is 219 or more and 862 or less.

### Advantages of the Invention

According to the present invention, it is possible to improve the insulating property of a covering layer containing a filler, which is disposed on at least a part of a surface of a negative composite layer.

### BRIEF DESCRIPTION OF THE DRAWINGS

FIG. 1: an illustrative view of a flaky graphite particle.

FIG. 2: a perspective view of an appearance showing an embodiment of a nonaqueous electrolyte energy storage device according to the present invention.

FIG. 3: a schematic view showing an energy storage apparatus having a plurality of nonaqueous electrolyte energy storage devices according to the present invention.

### MODE FOR CARRYING OUT THE INVENTION

The configuration and effects of the present invention will be described together with the technical concept. However, the operation mechanism includes presumptions, and whether it is right or wrong does not limit the present invention. In addition, the present invention can be carried out in various other forms without departing from the spirit or main feature thereof. Accordingly, the embodiments and experimental examples given below are merely examples in every way, and they should not be construed as restrictive. Further, variations and modifications falling under the scope equivalent to the claims are all within the scope of the present invention.

In an embodiment of the present invention, a negative electrode for a nonaqueous electrolyte energy storage device includes a negative electrode including a current collector, a negative composite layer containing a negative active material, and a covering layer containing a filler on at least a part of a surface of the negative composite layer.

Furthermore, in the negative electrode for a nonaqueous electrolyte energy storage device, a peak intensity ratio (I₍₀₀₂₎/I₍₁₀₀₎) between a diffraction peak attributed to (002) plane of the negative active material and a diffraction peak attributed to (100) plane of the negative active material is 219 or more and 862 or less in X-ray diffraction (XRD) measurement.

As described in EXAMPLES described later, when the peak intensity ratio (I₍₀₀₂₎/I₍₁₀₀₎) is 219 or more and 862 or less, the infiltration of the filler in the covering layer into the negative composite layer can be suppressed, and therefore the insulating property of the covering layer is improved.

A specific measurement method of the peak intensity ratio will be described in EXAMPLES described later.

Further, in an embodiment of the present invention, the negative electrode for nonaqueous electrolyte energy storage device contains flaky graphite as a negative active material of the negative composite layer. The percentage of the flaky graphite existing in the negative active material is 10% by mass or more and 60% by mass or less.

Accordingly, since the infiltration of the filler in the covering layer into the negative composite layer can be suppressed, this contributes to an improvement of the insulating property of the covering layer.

When the percentage of the flaky graphite in the negative active material of the negative composite layer is more than 60% by mass, it is not preferred since the ability of the nonaqueous electrolyte solution to penetrate into the negative composite layer becomes weak and charge-discharge characteristics of the nonaqueous electrolyte energy storage device are deteriorated.

Further, the percentage of the flaky graphite in the negative active material of the negative composite layer is preferably more than 10% by mass and 20% by mass or less since charge-discharge characteristics of the nonaqueous electrolyte energy storage device are improved.

Further, the percentage of the flaky graphite existing in the vicinity of the surface of the negative composite layer increases as the percentage of the flaky graphite contained in the negative composite layer increases. Thus, it is supposed that even if conditions in pressing the negative composite layer are relaxed, the peak intensity ratio (I₍₀₀₂₎/I₍₁₀₀₎) falls within the range of 219 or more and 862 or less to enable suppression of the infiltration of the filler into the negative composite layer, and therefore the insulating property of the covering layer is improved.

It is preferred from this supposition that the percentage of the flaky graphite in the negative active material of the negative composite layer is 20% by mass or more.

The percentage of the flaky graphite contained in the negative active material can be measured by the following method.

A nonaqueous electrolyte energy storage device discharged until a state of charge (SOC) of the nonaqueous electrolyte energy storage device reaches 0% (end-of-discharge state) is disassembled in an environment of −20° C. (dew point) or lower, the negative electrode is taken out, and then a portion of the negative electrode not opposed to the positive electrode is cut out. An electrolyte solution component adhered to the negative electrode is washed out using a solvent such as dimethyl carbonate (DMC), and the solvent is removed by drying. A cross section portion formed by subjecting the resulting negative electrode to cross section processing using a cross section polisher or the like is observed with a scanning electron microscope (SEM), and thereby the percentage of the flaky graphite contained in the negative active material can be determined.

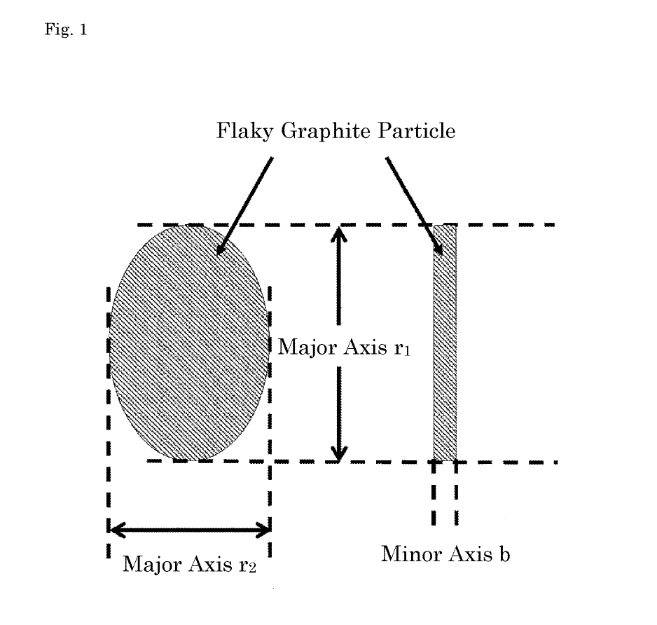

The flaky graphite will be described with reference to FIG. 1.

The flaky graphite in the embodiment of the present invention is particles satisfying the following conditions (1) to (3):

(1) it has three parameters of length (r1, r2, and b);
(2) the three parameters satisfy a relation of r1≧r2>b; and
(3) when the average of r1 and r2 is taken as “a,” it has an aspect ratio (a/b) of 5 or more.

In an embodiment of the present invention, the aspect ratio of the flaky graphite preferably has a relation of 5≧a/b≦80. The aspect ratio preferably falls within this range since the infiltration of the filler in the covering layer into the negative composite layer can be suppressed more efficiently. The aspect ratio more preferably has a relation of 10≦a/b≦60, and particularly preferably a relation of 20≦a/b≦40.

Examples of a measurement method of the aspect ratio of the flaky graphite contained in the negative electrode for a nonaqueous electrolyte energy storage device of the embodiment of the present invention include the following method.

A nonaqueous electrolyte energy storage device discharged to a state of charge (SOC)=0% (end-of-discharge state) is disassembled in an environment of −20° C. (dew point) or lower, the negative electrode is taken out, and then a portion of the negative electrode not opposed to the positive electrode is cut out. An electrolyte solution component adhered to the negative electrode is washed out using a solvent such as dimethyl carbonate (DMC), and the solvent is removed by drying. A cross section portion formed by subjecting the resulting negative electrode to cross section processing using a cross section polisher or the like is observed at about five points with a scanning electron microscope (SEM). The parameters r1, r2 and b of a plurality of flaky graphite particles are measured and their average values are calculated.

Alternatively, the following method can also be employed. The nonaqueous electrolyte energy storage device is disassembled, the negative electrode is taken out, and then a portion of the negative electrode not opposed to the positive electrode is immersed in a solvent. Then, the negative active material is separated from the solution containing the negative active material and a binder by filtration, and the negative active material is observed with an optical microscope. Then, the parameters r1, r2 and b of a plurality of flaky graphite particles are measured and their average values are calculated.

In an embodiment of the present invention, when the thickness of a region of the negative composite layer, into which the filler in the covering layer infiltrates, is defined as d1 and the thickness of the covering layer is defined as d2, the ratio (d1/d2) of d1 to d2 is preferably 1.0 or less. The region of the negative composite layer, into which the filler in the covering layer infiltrates, is preferably reduced as described above since the insulating property of the covering layer can be improved.

Examples of a measurement method of d1 and d2 include the following method.

A nonaqueous electrolyte energy storage device discharged to a state of charge (SOC)=0% (end-of-discharge state) is disassembled in an environment of −20° C. (dew point) or lower, the negative electrode is taken out, and then a portion of the negative electrode not opposed to the positive electrode is cut out. An electrolyte solution component adhered to the negative electrode is washed out using a solvent such as dimethyl carbonate (DMC), and the solvent is removed by drying. A cross section portion formed by subjecting the resulting negative electrode to cross section processing using a cross section polisher or the like is observed at a plurality of points with a scanning electron microscope (SEM). From the resulting SEM images, an average value of each of filler-infiltrated regions (infiltration distances) and thicknesses of the covering layer is calculated, and the ratio (d1/d2) between these two average values is determined.

Alternatively, d1 and d2 may be identified by analyzing the negative electrode subjected to cross section processing with an electron probe micro analyzer (EPMA).

In an embodiment of the present invention, a negative active material other than the flaky graphite which is contained in the negative active material is not limited as long as its particle shape is not flaky, and the negative active material may be any material capable of storing or releasing lithium ions.

Examples thereof include titanium-based materials such as lithium titanate having a spinel crystal structure typified by Li[Li_{1/3}Ti_{5/3}]O₄; alloy-based materials including Si, Sb, and Sn alloys; lithium metal; lithium alloys (lithium-silicon, lithium-aluminum, lithium-lead, lithium-tin, lithium-aluminum-tin, lithium-gallium, and lithium metal-containing alloys such as wood's metal); oxides such as silicon oxide; and carbon materials (e.g., graphite, hard carbon, low-temperature baked carbon, and amorphous carbon).

Among these negative active materials, carbon materials are preferred for titanium-based materials from the viewpoint of charge-discharge capacity, and for alloy-based materials, lithium metal, and oxides from the viewpoint of the cycle performance. Furthermore, graphite is particularly preferred among the carbon materials.

Further, the negative active material may contain a small amount of typical nonmetal elements such as B, N, P, F, Cl, Br and I, a small amount of typical metal elements such as Li, Na, Mg, Al, K, Ca, Zn, Ga and Ge, and a small amount of transition metal elements such as Sc, Ti, V, Cr, Mn, Fe, Co, Ni, Cu, Mo, Zr, Ta, Hf, Nb and W as long as the effect of the present invention is not impaired.

A binder to be used for the negative composite layer may be either of a water-based binder and an organic solvent-based binder.

Herein, examples of the binder include polyvinylidene fluoride (PVDF), a styrene-butadiene rubber (SBR), an acrylonitrile-butadiene rubber (NBR), a methylmethacrylate-butadiene rubber (MBR), polymethyl methacrylate (PMMA), and polyacrylonitrile (PAN).

The addition amount of the binder is preferably 1 to 50% by mass, and particularly preferably 2 to 30% by mass with respect to the total mass of the negative electrode.

The thickness of the negative composite layer is preferably 30 to 120 μm from the viewpoint of charge-discharge characteristics.

As a filler to be used for the covering layer, an inorganic oxide which is electrochemically stable even at a negative electrode potential of a nonaqueous electrolyte energy storage device in a state of full charge is preferred. Furthermore, from the viewpoint of enhancing heat resistance of the covering layer, an inorganic oxide having heat resistance to a temperature of 250° C. or higher is more preferred. Examples thereof include alumina, silica, zirconia, and titania. Among these inorganic oxides, alumina and titania are particularly preferred.

The above-mentioned fillers may be used singly or may be used as a mixture of two or more thereof.

As to the shape of the filler to be used for the covering layer, the filler is preferably polycrystalline particles having a dendritic, coral-like or tufted shape in order to prevent the covering layer from being excessively filled with the filler. However, the shape is not limited to these.

The particle size (mode diameter) of the filler to be used for the covering layer is preferably 0.1 μm or more.

Furthermore, from the viewpoint of reducing the infiltration of the filler into the composite layer, the particle size of the filler is particularly preferably 1 μm or more.

Examples of a binder for the covering layer include the following compounds; however, the binder is not limited to these compounds.

For example, fluororesins such as polyvinylidene fluoride (PVDF), polytetrafluoroethylene (PTFE), a polytetrafluoroethylene-hexafluoropropylene copolymer (FEP), polyacrylic acid derivatives, polyacrylonitrile derivatives, polyethylene, rubber-based binders such as a styrene-butadiene rubber, and polyacrylonitrile derivatives can be mentioned.

The polyacrylic acid derivatives and the polyacrylonitrile derivatives preferably include at least one selected from the group consisting of a methyl acrylate unit, an ethyl acrylate unit, a methyl methacrylate unit and an ethyl methacrylate unit in addition to an acrylic acid unit and/or an acrylonitrile unit.

Among these, polyacrylonitrile derivatives which are polymers including an acrylonitrile unit are preferred since they can improve flexibility of the covering layer, resulting in the prevention of cracks of the negative electrode or exfoliation of the negative composite layer which occur during winding operation in preparing an electrode group.

In order to prevent the covering layer and the negative composite layer from mixing with each other, an organic solvent-based binder is preferably used for the covering layer when a water-based binder is used for the negative composite layer. Similarly, a water-based binder is preferably used for the covering layer when an organic solvent-based binder is used for the negative composite layer.

The amount of the binder contained in the covering layer is preferably 1 part by mass or more and 50 parts by mass or less with respect to 100 parts by mass of the filler. The amount of the binder is more preferably 1 part by mass or more and 5 parts by mass or less.

The thickness of the covering layer is preferably 0.1 μm or more and 30 μm or less from the viewpoint of energy density of a battery. Further, the thickness of the covering layer is more preferably 1 μm or more and 30 μm or less from the viewpoint of improvement of reliability of a battery, and particularly preferably 1 μm or more and 10 μm or less from the viewpoint of charge-discharge characteristics of the nonaqueous electrolyte energy storage device.

The porosity of the negative composite layer is preferably 15% or more and 40% or less. From the viewpoint of reducing the infiltration of the filler into the negative composite layer, the porosity is more preferably 15% or more and 30% or less.

The insulating property of the covering layer of the negative electrode is preferably 188 Ω/cm² or more. A negative electrode having such an insulating property is preferable since the safety at the time of internal short-circuit due to an unforeseen situation can be improved. The insulating property of the covering layer is more preferably 218 Ω/cm² or more.

The insulating property of the covering layer of the negative electrode is preferably 567 Ω/cm² or less, and more preferably 472 Ω/cm² or less from the viewpoint of charge-discharge characteristics of the nonaqueous electrolyte energy storage device.

Examples of the material of the current collector, such as current collecting foil, to be used for the negative electrode include metal materials such as copper, nickel, stainless steel, nickel-plated steel, and chromium-plated steel. Among these materials, copper is preferred from the viewpoint of ease of processing, cost and electric conductivity.

In an embodiment of the present invention, a method of preparing the negative electrode is not particularly limited, and for example, the following method may be employed.

As described in EXAMPLES described later, a negative composite layer is prepared by applying, onto a current collector, a negative electrode paste containing a negative active material, a binder and a solvent and then drying the paste, the thickness of the negative composite layer is adjusted to a predetermined thickness by carrying out pressing, and a covering layer is prepared by applying, onto the negative composite layer, a covering paste containing a filler, a binder and a solvent, then drying the covering paste, and subsequently carrying out pressing, and thereby a negative electrode is prepared.

The negative electrode can also be formed by the following method: a negative composite layer is prepared by applying, onto a current collector, a negative electrode paste containing a negative active material, a binder and a solvent and then drying the paste, and a covering layer is prepared by applying, onto the negative composite layer, a covering paste containing a filler, a binder and a solvent, then drying the covering paste, and subsequently carrying out pressing.

As described above, the peak intensity ratio (I₍₀₀₂₎/I₍₁₀₀₎) of an X-ray diffraction peak of the negative electrode can be set to 219 or more and 862 or less (by the pressing step in preparing the covering layer) even by a method of preparing the covering layer without carrying out pressing after preparing the negative composite layer, and therefore advantages of the present invention are achieved.

Furthermore, since the step of pressing after preparation of the negative composite layer can be omitted, the method is preferred since the production cost can be reduced.

In the above-mentioned method of preparing the negative electrode, a conductive agent or various additives may be contained in the negative electrode paste.

The positive active material is not particularly limited as long as it is higher in reversible potential due to charge-discharge than the negative active material is. Examples of the positive active material include lithium transition metal composite oxides such as LiCoO₂, LiMn₂O₄, LiNiCoO₂, LiNiMnCoO₂, Li(Ni_{0.5}Mn_{1.5})O₄, Li₄Ti₅O₁₂ and LiV₃O₈, lithium-excess transition metal composite oxides such as Li[LiNiMnCo]O₂, polyanion compounds such as LiFePO₄, LiMnPO₄, Li₃V₂(PO₄)₃ and Li₂MnSiO₄, iron sulfide, iron fluoride, and sulfur.

The positive electrode is suitably prepared by adding and kneading a positive active material, a conductive agent, a binder, and an organic solvent such as N-methylpyrrolidone or toluene or water to form a positive electrode paste, applying the positive electrode paste onto a current collector such as aluminum foil, and subjecting the paste to a heating treatment at a temperature of about 50° C. to 250° C. The application method is preferably carried out to give an arbitrary thickness and an arbitrary shape by using means such as roller coating with an applicator roll or the like, screen coating, doctor blade coating, spin coating, and bar coater coating; however, the method is not limited thereto.

A nonaqueous electrolyte to be used for the nonaqueous electrolyte energy storage device of the present embodiment is not particularly limited, and, for example, those generally proposed for use for lithium batteries can be used. Examples of a nonaqueous solvent to be used for the nonaqueous electrolyte include, but are not limited to, one compound or a mixture of two or more of compounds of cyclic carbonate esters such as propylene carbonate, ethylene carbonate, butylene carbonate, chloroethylene carbonate, and vinylene carbonate; cyclic esters such as γ-butyrolactone and γ-valerolactone; chain carbonates such as dimethyl carbonate, diethyl carbonate, and ethylmethyl carbonate; chain esters such as methyl formate, methyl acetate, and methyl butyrate; tetrahydrofuran and derivatives thereof, ethers such as 1,3-dioxane, 1,4-dioxane, 1,2-dimethoxyethane, 1,4-dibutoxyethane, and methyl diglyme; nitriles such as acetonitrile and benzonitrile; dioxolan and derivatives thereof, and ethylene sulfide, sulfolane, sultone and derivatives thereof.

Examples of an electrolyte salt to be used for the nonaqueous electrolyte include inorganic ion salts having one of lithium (Li), sodium (Na) and potassium (K), such as LiClO₄, LiBF₄, LiAsF₆, LiPF₆, LiSCN, LiBr, LiI, Li₂SO₄, Li₂B₁₀Cl₁₀, NaClO₄, NaI, NaSCN, NaBr, KClO₄, and KSCN, and organic ion salts such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄, NClO₄, (n-C₄H₉)₄NI, (C₂H₅)₄N-maleate, (C₂H₅)₄N-benzoate, (C₂H₅)₄N-phtalate, lithium stearylsulfonate, lithium octylsulfonate and lithium dodecylbenzenesulfonate, and these ionic compounds can be used singly or in combination of two or more thereof.

Further, by mixing LiPF₆ or LiBF₄ with a lithium salt having a perfluoroalkyl group, such as LiN(C₂F₅SO₂)₂, the viscosity of the electrolyte can be further reduced. Therefore, the low-temperature characteristic can be further improved, and self discharge can be suppressed, and thus the use of the mixture is more desirable.

Further, an ambient temperature molten salt or an ionic liquid may be used as a nonaqueous electrolyte.

The concentration of the lithium ions (Li⁺) in the nonaqueous electrolyte solution is preferably 0.1 mol/1 to 5 mol/1, more preferably 0.5 mol/1 to 2.5 mol/1, and particularly preferably 0.8 mol/1 to 1.0 mol/1 for obtaining a nonaqueous electrolyte energy storage device having high charge-discharge characteristics.

As a separator, it is preferred that a porous membrane, a nonwoven fabric or the like, which shows excellent high rate discharge performance, be used singly or in combination. Examples of the material constituting the separator include polyolefin-based resins typified by polyethylene, polypropylene and the like, polyester-based resins typified by polyethylene terephthalate, polybutylene terephthalate and the like, polyvinylidene fluoride, a vinylidene fluoride-hexafluoropropylene copolymer, a vinylidene fluoride-perfluoro vinyl ether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, various amide-based resins, various celluloses, and polyethylene oxide-based resins.

Further, examples of the material constituting the separator include a polymer gel formed of a polymer, such as acrylonitrile, ethylene oxide, propylene oxide, methyl methacrylate, vinyl acetate, vinyl pyrrolidone, or polyvinylidene fluoride, and an electrolyte.

Further, when the above-mentioned porous membrane, nonwoven fabric, or the like is used in combination with a polymer gel as a separator, it is desirable since the combination use improves the liquid retainability of an electrolyte solution. That is, when the surface and the micropore wall surface of a polyethylene microporous membrane are covered with a solvent-compatible polymer to a thickness of several micrometers or less to form a film, and an electrolyte is retained in the micropores of the film, the solvent-compatible polymer turns into a gel.

Examples of the solvent-compatible polymer include, in addition to polyvinylidene fluoride, polymers having a crosslinkage of an acrylate monomer having an ethylene oxide group, an ester group or the like, an epoxy monomer, a monomer having an isocyanato group or the like. The monomer can be subjected to a crosslinking reaction by carrying out heating using a radical initiator in combination, or using active light rays such as or using an ultraviolet ray (UV) or an electron beam (EB).

Further, as shown in EXAMPLES described later, a surface layer containing an inorganic filler may be disposed on the surface of the separator. When a separator including the surface layer containing an inorganic filler is used, thermal shrinkage of the separator is suppressed, and therefore internal short-circuit can be reduced or prevented even if the energy storage device reaches a temperature higher than a normal operating temperature region. Thus, this configuration is preferred since safety of the energy storage device can be improved.

Examples of the inorganic filler include inorganic oxides, inorganic nitrides, slightly soluble ion-binding compounds, covalent compounds, and clay minerals such as montmorillonite.

Examples of the inorganic oxide include iron oxide, silica (SiO₂), alumina (Al₂O₃), titanium oxide (TiO₂), barium titanate (BaTiO₃), and zirconium oxide (ZrO₂).

Examples of the inorganic nitride include aluminum nitride and silicon nitride.

Examples of the slightly soluble ion-binding compound include calcium fluoride, barium fluoride, and barium sulfate.

Herein, the inorganic oxide may be a material derived from a mineral source such as boehmite, zeolite, apatite, kaolin, mullite, spinel, olivine and mica, or a manmade substance thereof. Further, the inorganic oxide may be particles which are provided with the electrical insulating property by covering the surface of a conductive material including conductive oxides such as metal, SnO₂ and indium-tin oxide (ITO); and carbonaceous materials such as carbon black and graphite with a material having an electrical insulating property (e.g., the above-mentioned inorganic oxide).

Among these inorganic oxides, silica, alumina, titanium oxide, zirconium oxide, and boehmite are particularly preferably used.

Further, when the surface layer containing an inorganic filler is arranged so as to be opposed to the positive electrode in forming an energy storage device, it is more preferred since the safety of an energy storage device can be further improved.

The porosity of the separator is preferably 98% by volume or less from the viewpoint of the strength. The porosity is preferably 20% by volume or more from the viewpoint of charge-discharge characteristics.

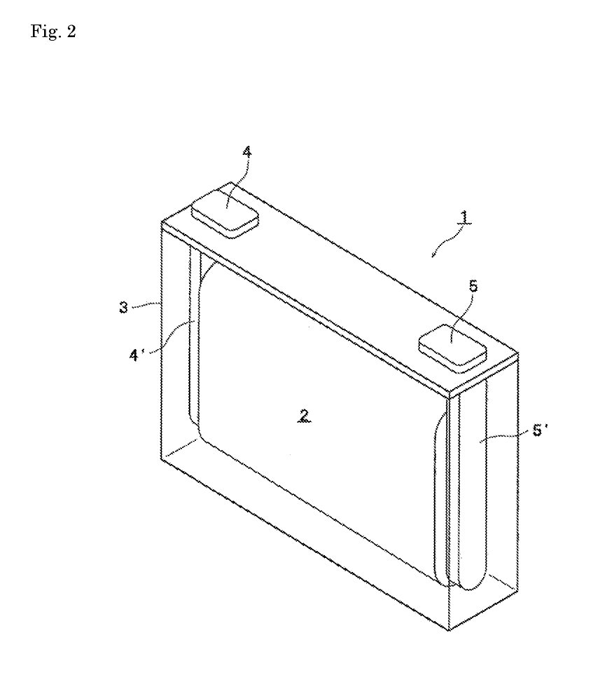

FIG. 2 shows a schematic view of a rectangular nonaqueous electrolyte energy storage device 1 of an embodiment of the nonaqueous electrolyte energy storage device according to the present invention. FIG. 2 is a perspective view of the inside of a container. In the nonaqueous electrolyte energy storage device 1 shown in FIG. 2, an electrode group 2 is housed in an outer case 3. The electrode group 2 is formed by winding a positive electrode and a negative electrode including a covering layer with a separator interposed therebetween. The positive electrode is electrically connected to a positive electrode terminal 4 with a positive electrode lead 4′ interposed therebetween, and the negative electrode is electrically connected to a negative electrode terminal 5 with a negative electrode lead 5′ interposed therebetween. The nonaqueous electrolyte is held in the outer case and within the separator.

The shape of the nonaqueous electrolyte energy storage device according to the present invention is not particularly limited, and examples thereof include cylindrical, prismatic (rectangular) and flat nonaqueous electrolyte energy storage devices.

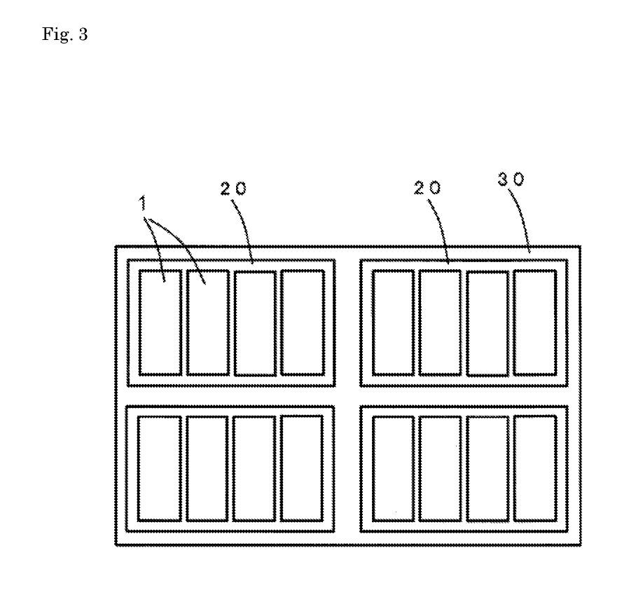

The present invention can also be realized as an energy storage apparatus having a plurality of nonaqueous electrolyte energy storage devices as described above. An embodiment of the energy storage apparatus is shown in FIG. 3. In FIG. 3, an energy storage apparatus 30 includes a plurality of energy storage units 20. Each of the energy storage units 20 includes a plurality of nonaqueous electrolyte energy storage devices 1. The energy storage apparatus 30 can be mounted as a power source for automobiles such as electric vehicles (EV), hybrid electric vehicles (HEV) and plug-in hybrid electric vehicles (PHEV).

In EXAMPLES described below, a lithium ion secondary battery will be described as an example of a nonaqueous electrolyte energy storage device; however, the present invention is applicable not only to the lithium ion secondary battery and but also to other nonaqueous electrolyte energy storage devices.

### Example 1

(Preparation of Negative Composite Layer)

A negative electrode paste was prepared using a spherical graphite and flaky graphite (aspect ratio 50) each serving as a negative active material, a styrene-butadiene rubber (SBR) and carboxymethyl cellulose (CMC) each serving as a binder as well as water serving as a solvent. The mass ratio between the spherical graphite and the flaky graphite was set to 85:15, the mass ratio between SBR and CMC was set to 5:3, and the mass ratio between the negative active material and the binder was set to 92:8.

The negative electrode paste was prepared by adjusting the amount of water to adjust the solid content (% by mass), and carrying out a kneading step using a multi blender mill. In the present example, the solid content concentration of the negative electrode paste was adjusted to 50% by mass. The negative electrode paste was applied onto both surfaces of copper foil with an unapplied portion (region on which a negative composite layer was not formed) left, and dried at 120° C., and thereby a negative composite layer was prepared.

After preparing the negative composite layer as described above, roll pressing was carried out in such a way that the thickness of the negative composite layer was 70 μm.

(Preparation of Covering Layer)

A covering paste was prepared using alumina (mode diameter 1 μm) serving as a filler, polyvinylidene fluoride (PVDF) (PVDF #9130 manufactured by KUREHA CORPORATION) serving as a binder and N-methylpyrrolidone (NMP) serving as a solvent. The mass ratio between the filler and the binder was set to 94:6 (in terms of solid content).

The covering paste was prepared by adjusting the amount of the solvent to adjust the solid content (% by mass), and carrying out a kneading step using a multi blender mill. In the present example, the solid content concentration of the covering paste was adjusted to 30% by mass. The covering paste was applied so as to cover the negative composite layer and vacuum dried (at 100° C. for 24 hours) to prepare a negative electrode. The thickness of the covering layer in the negative electrode was 7 μm and the porosity of the negative composite layer was 30%.

### Example 2

A negative electrode of Example 2 was prepared in the same manner as in Example 1 except that the mass ratio between the spherical graphite and the flaky graphite which were each a negative active material was changed to 80:20.

### Example 3

A negative electrode of Example 3 was prepared in the same manner as in Example 1 except that the mass ratio between the spherical graphite and the flaky graphite which were each a negative active material was changed to 70:30.

### Example 4

A negative electrode of Example 4 was prepared in the same manner as in Example 1 except that the mass ratio between the spherical graphite and the flaky graphite which were each a negative active material was changed to 60:40.

### Example 5

A negative electrode of Example 5 was prepared in the same manner as in Example 1 except that the mass ratio between the spherical graphite and the flaky graphite which were each a negative active material was changed to 40:60.

### Example 6

A negative electrode of Example 6 was prepared in the same manner as in Example 1 except that the mass ratio between the spherical graphite and the flaky graphite which were each a negative active material was changed to 90:10.

### Example 7

A negative electrode of Example 7 was prepared in the same manner as in Example 1 except that the mass ratio between the spherical graphite and the flaky graphite which were each a negative active material was changed to 90:10 and flat plate pressing was carried out after preparation of the negative composite layer so that the thickness of the negative composite layer would be 70 μm.

### Comparative Example 1

A negative electrode of Comparative Example 1 was prepared in the same manner as in Example 1 except that only the spherical graphite was used as a negative active material.

(Reference Example 1) A negative electrode was prepared in the same manner as in Example 1 except that the mass ratio between the spherical graphite and the flaky graphite which were each a negative active material was changed to 90:10 and pressing was not carried out after preparation of the negative composite layer. The thickness of the negative composite layer was 97 μm.

### Reference Example 2

A negative electrode was prepared in the same manner as in Example 1 except that the mass ratio between the spherical graphite and the flaky graphite which were each a negative active material was changed to 90:10 and roll pressing was carried out in such a way that the thickness of the negative composite layer would be 85 μm.

(Measurement of Insulating Property)

The negative electrode of each of examples, comparative example and reference examples was overlaid on aluminum foil (having a thickness of 10 μm) so as to be opposed to each other, and a pressure of 0.34 kgf/cm² was applied to an opposed portion using a metal weight made of SUS. A DC resistance value between the negative electrode and the aluminum foil then was measured with a low-resistance meter (manufactured by TSURUGA ELECTRIC CORPORATION, Model 3566). The opposed portion was a square with an area of 5.3 cm².

The DC resistance value was recorded as an “insulating property” of the covering layer.

(Preparation of Positive Electrode)

A positive electrode paste was prepared using a lithium-cobalt-nickel-manganese composite oxide (compositional formula: LiCo_{1/3}Ni_{1/3}Mn_{1/3}O₂) serving as a positive active material, acetylene black (AB) serving as a conductive agent, polyvinylidene fluoride (PVDF) serving as a binder and NMP serving as a nonaqueous solvent. A 12% NMP solution (#1100 manufactured by KUREHA CORPORATION) was used as the PVDF. The mass ratio among the positive active material, the binder and the conductive agent was set to 90:5:5 (in terms of solid content). The positive electrode paste was applied onto both surfaces of aluminum foil with an unapplied portion left, and dried. Thereafter, roll pressing was carried out to prepare a positive electrode.

(Nonaqueous Electrolyte Solution)

A nonaqueous electrolyte was prepared by dissolving LiPF₆ so that the salt concentration would be 1.2 mol/L in a solvent formed by mixing 30 vol % of propylene carbonate, 40 vol % of dimethyl carbonate and 30 vol % of ethyl methyl carbonate. The water content in the nonaqueous electrolyte was adjusted to less than 50 ppm.

(Separator)

For a separator, one which is provided with a surface layer containing an inorganic filler on a surface of a polyethylene microporous membrane having a thickness of 21 μm was used.

(Assembling of Battery)

A positive electrode, the negative electrode of each of examples, comparative example and reference examples, and a separator were laminated and wound. The positive electrode, negative electrode and separator were laminated so that the surface layer containing an inorganic filler would be opposed to the positive electrode.

Thereafter, a region of the positive electrode having no positive composite layer and a region of the negative electrode having no negative composite layer were welded to a positive electrode lead and a negative electrode lead, respectively, and enclosed in a container. A lid was welded to the container, and then a nonaqueous electrolyte was poured into the container and the opening was sealed.

(Initial Activation Step)

Each of batteries thus prepared was subjected to the following initial activation step in a thermostatic oven set at 25° C.

With respect to charge conditions of the initial activation step, constant current constant voltage charge with a current value of 1 CA and a voltage of 4.2 V was employed. The charge time was set to 7 hours from the start of energization. With respect to discharge conditions, constant current discharge with a current of 1 CA and an end voltage of 2.75 V was employed.

The “1 CA,” which is a current value, refers to a current value at which the electric quantity is the same as the nominal capacity of the battery in performing constant current energization of the battery for 1 hour.

(X-ray Diffraction Measurement)

Each battery after the initial activation was discharged so that the state of charge (SOC) would reach 0% (end-of-discharge state). The battery after discharge was disassembled in an atmosphere of −20° C. (dew point) or lower, the negative electrode was taken out, and a portion of the negative electrode not opposed to the positive electrode was cut out. The portion was washed with dimethyl carbonate (DMC) to remove a lithium salt adhered to the negative electrode, and then the solvent was removed by drying.

X-ray diffraction (XRD) measurement was carried out on a negative electrode sample thus obtained.

An X-ray diffractometer (manufactured by Rigaku Corporation, Model: RINT PTR3) was used for measurement, and the following conditions were employed.

Light source: Cu-Kα

Output voltage: 50 kV

Output current: 300 mA

Scanning speed: 1°/sec

Step width: 0.03°

Scanning range: 10 to 100°

Slit width (receiving side): 0.3 mm

Data obtained by measurement was analyzed using PDXL 1.8.1, software attached to the X-ray diffractometer, to determine the peak intensity ratio (I₍₀₀₂₎/I₍₁₀₀₎) between the diffraction peak attributed to (002) plane of the negative active material and the diffraction peak attributed to (100) plane of the negative active material.

In analyzing X-ray diffraction data, a peak derived from Kα2 was not removed. Further, the intensity of a diffraction peak means the integral intensity of a diffraction peak.

Values of the peak intensity ratio of X-ray diffraction and the insulating property of the covering layer of examples, comparative example and reference examples are shown in Table 1.

TABLE 1

| | XRD | Insulating | Percentage of |
|---|---|---|---|
| | Intensity Ratio | Property | Flaky Graphite |
| | I₍₀₀₂₎/I₍₁₀₀₎ | (Ω) | (%) |
| Example 1 | 272 | 1062 | 15 |
| Example 2 | 283 | 1156 | 20 |
| Example 3 | — | 1543 | 30 |
| Example 4 | — | 3000 | 40 |
| Example 5 | 862 | 3000 | 60 |
| Example 6 | 219 | — | 10 |
| Example 7 | 226 | 245 | 10 |
| Comparative | 197 | 61.4 | 0 |
| Example 1 | | | |
| Reference | 60 | 17.3 | 10 |
| Example 1 | | | |
| Reference | 165 | 40.2 | 10 |
| Example 2 | | | |

As is apparent from Table 1, values of the insulating property of the covering layers of Examples 1, 2, 5 and 7 in which the peak intensity ratio (I₍₀₀₂₎/I₍₁₀₀₎) of X-ray diffraction is larger than 219 are outstandingly higher than values of the insulating property of Comparative Example 1 and Reference Examples 1 and 2. With respect to Examples 3 and 4, there is no data of the peak intensity ratio of X-ray diffraction, but the peak intensity ratios of X-ray diffraction are thought to be the same as the peak intensity ratios between those of Example 2 and Example 5 from the tendency of peak intensity ratios of X-ray diffraction of other examples and comparative example.

When the peak intensity ratio (I₍₀₀₂₎/I₍₁₀₀₎) of X-ray diffraction of the negative electrode is thus set within a specific range, a high insulating property of the negative electrode can be realized. Thus, the safety at the time of internal short-circuit of a battery or a nonaqueous electrolyte energy storage device due to an unforeseen situation can be improved.

The high insulating property of the covering layer in the specific range of the peak intensity ratio of X-ray diffraction is thought to result from the content of the flaky graphite in the negative composite layer of 10% by mass or more.

Since the flaky graphite is contained in the negative composite layer in an amount corresponding to a specific peak intensity ratio of X-ray diffraction, smoothness of the surface of the negative composite layer which faces an interface between the negative composite layer and the covering layer is improved to enable to suppress the infiltration of the filler in the covering layer into the negative composite layer. Therefore, this configuration is thought to improve the insulating property of the covering layer.

Further, from comparisons between Example 7 and Reference Example 1 and between Example 7 and Reference Example 2, it is found to be preferred that pressing conditions of the negative composite layer be adjusted so that the value of the peak intensity ratio of X-ray diffraction would fall within a specific range in order to improve the insulating property of the covering layer even when the same amount of flaky graphite is contained in the negative composite layer.

It is to be noted that while no test example is described, in the battery including the negative electrode in which the peak intensity ratio (I₍₀₀₂₎/I₍₁₀₀₎) of X-ray diffraction exceeds 862, the charge-discharge characteristics are deteriorated.

Further, the insulating property of the covering layer was measured using a portion on which X-ray diffraction measurement was not carried out, of the negative electrode which was taken out from the disassembled battery and was not opposed to the positive electrode. Consequently, approximately the same value as that before assembling the battery was obtained, and there were no change in the relationship between the XRD intensity ratio and the insulating property before and after assembling the battery.

### INDUSTRIAL APPLICABILITY

Since the present invention can improve the insulating property of a covering layer containing a filler disposed on at least a part of a surface of the negative composite layer and can improve the safety at the time of internal short-circuit of the nonaqueous electrolyte energy storage device due to an unforeseen situation, it is useful for nonaqueous electrolyte energy storage devices having wide applications such as a power supply for electric vehicles, a power supply for electronic equipment, and a power supply for electric power storage.

### DESCRIPTION OF REFERENCE SIGNS

1 Nonaqueous electrolyte energy storage device
2 Electrode group
3 Outer case
4 Positive electrode terminal
4′ Positive electrode lead
5 Negative electrode terminal
5′ Negative electrode lead
20 Energy storage unit
30 Energy storage apparatus

1. A negative electrode for a nonaqueous electrolyte energy storage device, comprising:
a negative electrode including a current collector, a negative composite layer containing a negative active material, and a covering layer containing a filler on at least a part of a surface of the negative composite layer,
wherein in X-ray diffraction (XRD) measurement of the negative electrode, a peak intensity ratio (I₍₀₀₂₎/I₍₁₀₀₎) between a diffraction peak attributed to (002) plane of the negative active material and a diffraction peak attributed to (100) plane of the negative active material is 219 or more and 862 or less.

2. A negative electrode for a nonaqueous electrolyte energy storage device, comprising:
a negative electrode including a current collector, a negative composite layer containing a negative active material, and a covering layer containing a filler on at least a part of a surface of the negative composite layer,
wherein the negative composite layer contains flaky graphite as a negative active material, and a percentage of the flaky graphite existing in the negative active material is 10% by mass or more and 60% by mass or less.

3. The negative electrode for a nonaqueous electrolyte energy storage device according to claim 1,
wherein the negative composite layer contains the filler, and a ratio (d1/d2) of a thickness of a region (d1) in which the filler exists to a thickness of the covering layer (d2) is 1.0 or less.

4. The negative electrode for a nonaqueous electrolyte energy storage device according to claim 2,
wherein a percentage of the flaky graphite existing in the negative active material is 20% by mass or more and 60% by mass or less.

5. The negative electrode for a nonaqueous electrolyte energy storage device according to claim 1,
wherein the filler has a particle size of 0.1 μm or more.

6. A nonaqueous electrolyte energy storage device comprising the negative electrode for a nonaqueous electrolyte energy storage device according to claim 1.

7. An energy storage apparatus comprising the nonaqueous electrolyte energy storage device according to claim 6.

8. The negative electrode for a nonaqueous electrolyte energy storage device according to claim 2,
wherein the negative composite layer contains the filler, and a ratio (d1/d2) of a thickness of a region (d1) in which the filler exists to a thickness of the covering layer (d2) is 1.0 or less.
